(19) United States
(12) Patent Application Publication
(10) Pub. No.: US 2011/0258459 A1
(43) Pub. Date: Oct. 20, 2011

(54) METHOD FOR PROTECTING THE DECRYPTING OF THE CONFIGURATION FILES FOR PROGRAMMABLE LOGIC CIRCUITS AND CIRCUIT IMPLEMENTING THE METHOD

(75) Inventors: Sylvain Guilley, Paris (FR); Jean-Luc Danger, Antony (FR); Laurent Sauvage, Jouy En Josas (FR)

(73) Assignee: INSTITUT TELECOM - TELECOM PARISTECH, Paris (FR)

(21) Appl. No.: 13/058,548

(22) PCT Filed: Jul. 30, 2009
(86) PCT No.: PCT/EP2009/059891

§ 371 Date: May 12, 2011

(30) Foreign Application Priority Data
Aug. 12, 2008 (FR) 0855536

(51) Int. Cl. G06F 21/02

(52) U.S. Cl. 713/189

(57) ABSTRACT

A method for protecting a programmable logic circuit includes storing data file(s) used for the configuration of the programmable resources of the circuit in a non-volatile memory after having been encrypted. A decryption module internal to the circuit is responsible for decrypting the file(s) by using a secret key stored in the circuit, the decryption module being protected against attacks aiming to obtain the key during the decryption operation by implementing at least one countermeasure technique.

The invention relates to a method for protecting the decrypting of the configuration files for programmable logic circuits of FPGA type, and a circuit implementing the method.

The invention applies notably to the fields of electronics and security of programmable logic circuits.

The economic model of the electronic components market has for more than a decade been experiencing a value transformation. Thus, the high-level description of the hardware to be generated, for example using the VHDL or Verilog languages, is the most strategic part and it is consequently necessary to protect it against counterfeiting.

Moreover, some circuits embed secret implementations. Such is the case with the content distribution market segments such as satellite television or the military with confidential algorithms and protocols.

Thus, for reasons concerning the fight against piracy, it is necessary to make the reverse engineering of the circuits impossible, or at least difficult. In the custom-designed products, such as ASIC circuits, reverse engineering becomes increasingly difficult with the reducing characteristic dimensions, currently of the order of a nanometre. However, the sensitive parts with high strategic value, or storing/processing confidential data, are still protected by ad hoc methods, such as, for example:
shielding by a metallization layer preventing direct microscope observation;
disposal of the logic complicating the visual identification of the resources;
scrambling of the data buses, which requires light cryptanalysis means in order to be able to interpret any identified resources.

Conversely, in the reconfigurable components, such as, for example, FPGAs, the information to be protected is available in the form of a configuration file, usually qualified by the term “bit stream”. In some FPGA families, this configuration file is stored in a non-volatile memory, a PROM for example, which can easily be extracted because it is soldered and therefore entirely readable. Since this memory is not on the value chain of the FPGA product designers, it is essential for its costs to be as low as possible. Consequently, these components usually have no security protection. In other FPGA families, the configuration file is saved directly within the FPGA matrix making it more complex to access.

There are, however, means, by using for example a shift register, for writing and sometimes also for reading this file. Since FPGAs are particularly vulnerable to attacks aimed at finding their configuration file, the big manufacturers offer countermeasure solutions integrated in the circuit.

In the current implementations, the reading of the configuration files is made difficult by encrypting them with symmetrical methods, such as, for example, the 3DES and AES algorithms. Furthermore, communication between said memory and the programmable logic circuit is also protected, because the decryption is usually performed on the chip of said circuit.

The decryption logic operation itself is not protected against attacks on its physical implementation. Thus, a smart attack can potentially find the encryption key and therefore then access the data contained in the configuration file.

To find this encryption key, two families of attacks can be implemented: observation attacks and disturbance or fault-injection attacks.

The first family of attacks, that is to say observation attacks, exploits the fact that the instantaneous electrical consumption of the circuit handling the encryption depends notably on the data processed. Several types of observation attacks are known. SPA (Simple Power Analysis) attempts to differentiate the operations executed by a central unit based on a measurement of its electrical consumption measured during a cryptographic operation. Differential consumption analysis DPA (Differential Power Analysis) uses statistical operations on numerous electrical consumption measurements, performed during cryptography operations on random messages and with a constant key to validate or invalidate an assumption made concerning a limited part of the key. “Template” type attacks use, in a first phase, a device that is identical to the device being attacked, apart from the fact that this identical device contains no secret, to construct consumption models indexed by the value of a limited part of the key and, in a second phase, use a few measurements of consumption of the device being attacked to determine the model for which the measured consumptions are closest and thus determine the value of this sub-key. Moreover, any electrical current flowing in a conductor generates an electromagnetic field, the measurement of which may give rise to attacks that are identical in principle to the attacks relying on electrical consumption, notably by DPA.

The second family of attacks, that is to say the disturbance or fault-injection attacks, introduce a disturbance into the system by virtue, for example, of a temperature or voltage variation, a strong spurious signal on the power supply or by electromagnetic field, a laser firing, etc. The faults generated cause the value of a node of the circuit being attacked to be modified. They may be singular or multiple, permanent or transient depending on the impact on the silicon. The flexibility of transient fault injections gives rise to more powerful attacks by doing multiple tests and increases the chances of success. Attacks with singular faults simplify the attack procedure. Fault-based attacks are based on differential analysis between the non-errored encrypted output and the output with fault.

The security model for the configuration files of programmable components is failing: physical attacks on the non-volatile memory containing the file are countered by encryption, but the decryption circuit on the programmable component is not protected and may be subject to a physical attack. It is thus possible to potentially isolate the encryption of data blocks of the configuration file, for example by using a trigger on the configuration clock and measuring the instantaneous magnetic signature. This analysis makes it possible to reassemble the encryption key, and therefore the decrypted configuration file.

One aim of the invention is notably to overcome the above-mentioned drawbacks.

To this end, the subject of the invention is a method for protecting a programmable logic circuit. The data file(s) used for the configuration of the programmable resources of the circuit are stored in a non-volatile memory after having been encrypted, a decryption module internal to the circuit being responsible for decrypting the file(s) by using a secret key stored in the circuit, the decryption module being protected against hidden channel attacks or fault-based attacks aiming to obtain the key during the decryption operation by implementing at least one countermeasure technique including: protection by differential logic, protection by masking and protection by fault detection.

The programmable logic circuit is, for example, of FPGA type.

The decryption module may be, for example, a dedicated logic circuit internal to the programmable logic circuit or else instantiated by programming the configurable resources of the programmable logic circuit.

Another subject of the invention is a programmable logic circuit of FPGA type, characterized in that it comprises at least one decryption module internal to the circuit responsible for decrypting the configuration file(s) for the programmable resources of said circuit by using a secret key stored in the circuit, the decryption module being protected against observation and/or fault-injection attacks during the decryption operation by using the method according to one of the preceding claims.

Other features and advantages of the invention will become apparent from the following description given as an illustrative and nonlimiting example, in light of the appended drawings in which:

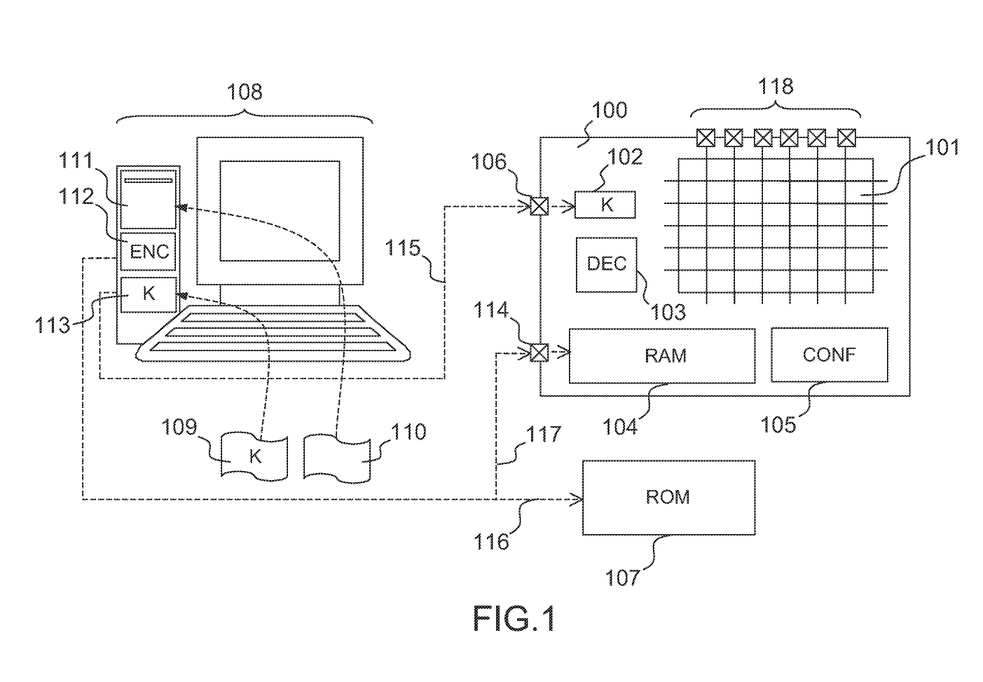

FIG. 1 illustrates an exemplary procedure for configuring a programmable logic circuit of FPGA type;

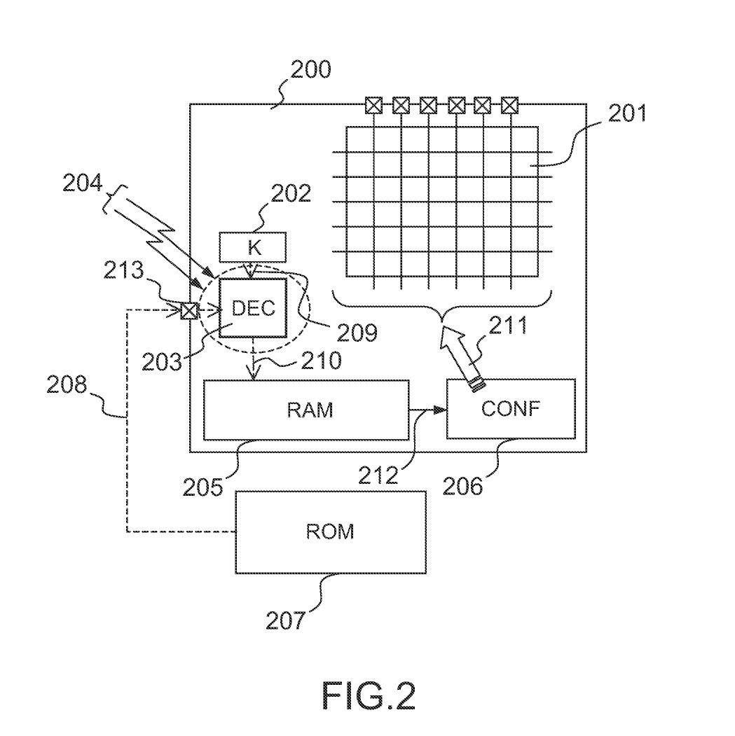

FIG. 2 illustrates an exemplary procedure for initializing a programmable logic circuit of FPGA type and the manner in which the decryption circuit is protected according to the invention.

FIG. 1 illustrates an exemplary procedure for configuring a programmable logic circuit of FPGA type. In this example, the FPGA 100 consists of a programmable resource area 101. Once programmed, said area can be used to produce the functions required for the application targeted by the designer. The programmable resource area consists notably of configurable logic blocks and interconnect resources between these blocks. The programmable resource area also comprises what are usually referred to as input/output blocks (IOB). These blocks are interconnected by programming, the IOBs making it possible to define the use of the input and output ports 118 of the FPGA. The FPGA 100 comprises a RAM volatile memory 104 used notably to store the configuration file. A configuration logic module 105 is used to connect the logic blocks and the IOBs together according to the program contained in volatile memory 104 in the configuration file. The FPGA 100 comprises a decryption module 103 that can be used to decrypt the configuration file and an area of non-volatile memory 102 containing the key required for decryption. A non-volatile memory 107, of PROM type for example, is used to store the encrypted configuration file. Thus, even when the system is powered down, the configuration information is kept in memory and protected against any attackers.

During the design of the system, the FPGA circuit is programmed so as to produce one or more functions according to the targeted application. For this, the designer uses, for example, a computer 108 with computer-aided design software (CAO). The designer programs said function or functions 110 using a high-level hardware description language, such as the VHDL language. The corresponding programs and data 111 result in a configuration file stored in the memory of the computer. The designer has the option to define an encryption key K 109 so as to protect said configuration data. This key is entered as a parameter 113. The configuration data 111 contained in the configuration file are encrypted using an encryption algorithm 112 such as, for example, AES or 3DES, using the key K 113. The encrypted configuration file is then placed 116 in the non-volatile memory 107. Another method is to place the encrypted configuration file directly 117 in the volatile memory 104 internal to the FPGA via an input port 114, and do so for system test purposes for example. For the programmable resource area 101 to be configured, it is necessary for the configuration file to be decrypted by the FPGA. For this, the key K is stored 102 inside the component and is transmitted 115 during the design phase via a port 106 of the FPGA.

FIG. 2 illustrates an exemplary procedure for initializing a programmable logic circuit of FPGA type and the manner in which the decryption circuit is protected according to the invention. As described previously, the encrypted configuration file is usually stored in a non-volatile memory 207 external to the FPGA 200. When the system is powered up, the encrypted configuration file is downloaded 208 and is presented as input to the decryption module 203 internal to the FPGA via, for example, an input port 213. The key K 202 is used 209 by the module 203 to decrypt the file and said file is transmitted 210 to the internal volatile memory 205. The configuration file is then used 212 by the configuration logic module 206 to configure 211 the programmable resource area 201.

The initialization procedure described above is triggered systematically each time the system is powered up. An attacker whose aim is to identify the key K stored 202 in the FPGA and then decrypt the configuration file may choose to study the operation of the decryption module 203 during the initialization of the system. This initialization is monitored by the attacker by, for example, the use of the synchronization clock used by the communication protocol between the ROM 207 and the FPGA 200. The decryption module is then attacked 204 by observation or disturbance injection.

So as to be protected from these attacks 204, the decryption module 203 may implement various countermeasure methods.

For example, the decryption module is protected against observation attacks, notably of DPA type, by using differential logic. Among the most common place differential logics there are, notably:
WDDL (Wave Dynamic Differential Logic) detailed in the article by K. Tiri and I. Verbauwhede entitled “A Logic Level Design Methodology for a Secure DPA Resistant ASIC or FPGA Implementation”, date, '04, pages 246-251, February 2004, Paris. The decryption module is in this case made up of two dual logic arrays working by complementary logic so as to make the consumption of the module virtually constant;
SECLIB (Secured Library) described in the article by S. Guilley, P. Hoogvorst, Y. Mathieu, R. Pacalet, J. Provost entitled “CMOS structures suitable for secured Hardware”, date, '04, pages 1414-1415, February 2004, Paris;
SABL described in the article by K. Tiri, M. Akmal and I. Verbauwhede entitled “A dynamic and Differential CMOS Logic with Signal Independant Power Consumption to Withstand Differential Power Analysis on Smart Cards”, ESSCIRC, pages 403-406, September 2002;
MCML described in the article by F. Regazzoni et al. entitled “A Simulation-Based Methodology for Evaluating DPA-Resistance of Cryptographic Functional Units with Application to CMOS and MCML Technologies”, SAMOS IC, July 2007;
DyMCL described in the article by M. W. Allam and M. I. Elmasry entitled “Dynamic Current Mode Logic (DyMCL), a new low-power/high-performance logic family”, 10.1109/CICC.2000.852699, pages 421-424, 2000;
TDPL described in the article by M. Burcci, L. Giancane, R. Luzzi and A. Trifiletti entitled “Three-phase dual-rail pre-charge logic”, CHESS, volume 4249 of LNCS, pages 232-241, Springer 2006.

Another way of safeguarding against the attacks on hidden channels is to use a mask on the variables. This mask has random values and can be used at the level of a function such as a logic gate.

The countermeasure techniques based on differential logic or masking are described notably in the book by Mangard Stefan, Oswald Elisabeth and Popp Thomas entitled “Power Analysis Attacks: Revealing the Secrets of Smart Cards”, Springer, 2007.

So as to be protected against fault-injection type disturbance attacks, the decryption circuit may be protected by using the fault detection technologies described for example in:
the article by Y. Kim, R. Karri and K. Wu entitled “Concurrent Error Detection Schemes for Fault Based Side-Channel Cryptanalysis of Symmetric Block Ciphers”, IEEE Transactions on Computer-Aided Design, 21(12), pages 1509-1517, December 2002;
the article by M. Karpovsky, K. Kulikowski and A. Taubin entitled “Robust Protection against Fault-Injection Attacks on Smart Cards Implementing the Advanced Encryption Standard”, IEEE Transactions on Computer-Aided Design, 21(2), May 2004;
the article by G. Bertoni, L. Breveglieri, I. Koren, P. Maistri, and V. Piuri entitled “Error Analysis and Detection Procedures for a Hardware Implementation of the Advanced Encryption Standard”, IEEE Transactions on Computer-Aided Design, 52(4), April 2003.

By using one or more of the abovementioned techniques, the protection of the decryption module is reinforced and this makes good the failing observed in the existing FPGAs. The security specification of the protection mechanism for programmable logic circuits is thus complemented with securing of the embedded crypto-processor so as to deal with physical observation or fault-injection attacks.

1. A method of protecting a programmable logic circuit, the method comprising storing one or more data file used for the configuration of the programmable resources of the circuit in a non-volatile memory after having been encrypted, wherein a decryption module internal to the circuit is responsible for decrypting the one or more data file by using a secret key stored in the circuit, the decryption module being protected against hidden channel attacks or fault-based attacks aiming to obtain the key during the decryption operation by implementing at least one countermeasure technique including: protection by differential logic, protection by masking and protection by fault detection.

2. The method according to claim 1, wherein the programmable logic circuit is of FPGA type.

3. The method according to claim 1, wherein the decryption module is a dedicated logic circuit internal to the programmable logic circuit.

4. The method according to claim 1, wherein the decryption module is instantiated by programming the configurable resources of the programmable logic circuit.

5. A programmable logic circuit of FPGA type, comprising at least one decryption module internal to the circuit responsible for decrypting one or more configuration file for the programmable resources of said circuit by using a secret key stored in the circuit, the decryption module being protected against observation and/or fault-injection attacks during the decryption operation by using the method according to claim 1.
